(19) United States
(12) Patent Application Publication
(10) Pub. No.: US 2003/0192738 A1
(43) Pub. Date: Oct. 16, 2003

(54) Fall protection system and method of fall protection

(76) Inventor: Joseph F. Gayetty, Franklin, PA (US)

Correspondence Address: HENRY E. BARTONY, JR., LAW & FINANCE BUILDING, SUITE 1801, 429 FOURTH AVENUE, PITTSBURGH, PA, 15219, US

(21) Appl. No.: 10/428,656

(22) Filed: May 2, 2003

Related U.S. Application Data
(62) Division of application No. 09/143,506, filed on Aug. 28, 1998.

(51) Int. Cl. A62B 1/16

(52) U.S. Cl. 182/18; 182/3

(57) ABSTRACT

A clearance indicator to protect a person using a lanyard comprises a measuring mechanism to measure the distance from an anchor point to a point at least a clearance distance from the anchor point, thereby providing an indication of whether the clearance required in the case of a fall is satisfied. A fall protection system comprises a lanyard including an attachment mechanism for attachment of a first end of the lanyard to an anchor point and the clearance indicator. A method of protecting a person using a lanyard while working at a height from a fall comprises the step of measuring the distance from an anchor point to at least a clearance distance from the anchor point to ensure than no obstacles will interrupt the person's fall.

### FIELD OF THE INVENTION

The present invention relates generally to a fall protection system and a method of fall protection, and, more particularly to a fall protection system and method of fall protection wherein an indication of the clearance required in the case of a fall is provided to the user before such a fall occurs.

### BACKGROUND OF THE INVENTION

Over the years a number of devices have been developed in an attempt to minimize the injury of a worker falling from a substantial height. Most commonly, a lifeline or lanyard is used to limit a worker's free fall distance to a specified distance. Such lifelines or lanyards are typically used with a safety harness worn by the worker.

Even in the case that a lanyard is used, however, the person using the lanyard must calculate the minimum unobstructed distance (that is, a clearance or minimum clearance distance) required in the case of a fall. In the case of a miscalculation, the user may strike an object below the user or strike the ground during a fall, leading to serious injury or even death.

It is thus very desirable to develop fall protection systems and methods that minimize or eliminate the above problem associated with lanyards used for fall restraint.

### SUMMARY OF THE INVENTION

In general, the present invention provides a clearance indicator to determine the clearance required for a person using a lanyard or lifeline. The clearance indicator comprises a measuring mechanism that measures the distance from an anchor point (to which the lanyard is or is to be anchored) to at least a clearance distance. The clearance indicator thus gives an indication to the user of whether the (unobstructed) clearance required in the case of a fall is satisfied before the fall occurs, thereby reducing the risk of injury.

The clearance indicator of the present invention can be used, for example, by a safety analyst or safety director, who typically identifies anchor points to be used by a crew of workers. Under current practice, such safety directors identify anchor points of suitable strength to support a worker, but have no mechanism to check for unobstructed clearance. The clearance indicator of the present invention can also be used by a person equipped with a lanyard.

Preferably, the clearance indicator comprises a length of material such as a nylon string or chord that is allowed to drop to extend and provide an indication of whether clearance is satisfied. The length of material preferably has a weight attached to the end thereof to facilitate extension of the length of material when dropped.

In one embodiment the present invention provides a fall protection system for use in protecting a person working at a height from a fall. The fall protection system comprises a lanyard including an attachment mechanism for attachment of a first end of the lanyard to an anchor point and a clearance indicator as described above.

In the case that the clearance indicator is used as a component of such a fall protection system, the clearance indicator is preferably attached to the lanyard. The clearance indicator can also, however, be attached directly to the anchor point. The fall protection system preferably further comprises a safety harness that includes an attachment mechanism to attach the second end of the lanyard to the safety harness.

In general, the clearance (and thus the length a length of material used in the clearance indicator) is calculated based upon addition of the length of the lanyard, the maximum extension of the lanyard under force of a fall, and the height of the person. In the case that the attachment mechanism of the safety harness (for example, an attachment ring attached to one or more of the straps of a safety harness) travels during a fall, the travel of the attachment mechanism of the safety harness should also be considered in calculation of the clearance.

The present invention also provides a method of protecting a person using a lanyard while working at a height from a fall. The method comprises the step of measuring the distance from an anchor point to a point at least a clearance distance from the anchor point to ensure than no obstacles will interrupt the person's fall, the clearance distance being a function of the length of the lanyard (and other factors as described above).

In one embodiment, the step measuring the distance from the anchor point to at least the clearance distance from the anchor point comprises the step of extending a length of material from a known position relative to the anchor point.

The clearance indicators and methods of the present invention provide a simple and inexpensive way to greatly increase the safety of persons working at heights.

### BRIEF DESCRIPTION OF THE DRAWINGS

FIG. 1A illustrates the appropriate use of a lanyard in fall protection.

FIG. 1B illustrates an accident occurring in the case that the minimum clearance required in the case of a fall is miscalculated.

FIG. 2A illustrates and embodiment of the present invention.

FIG. 2B illustrates an exploded view of the attachment of a clearance indicator to the lanyard of the fall protection system of FIG. 2A.

### DETAILED DESCRIPTION OF THE INVENTION

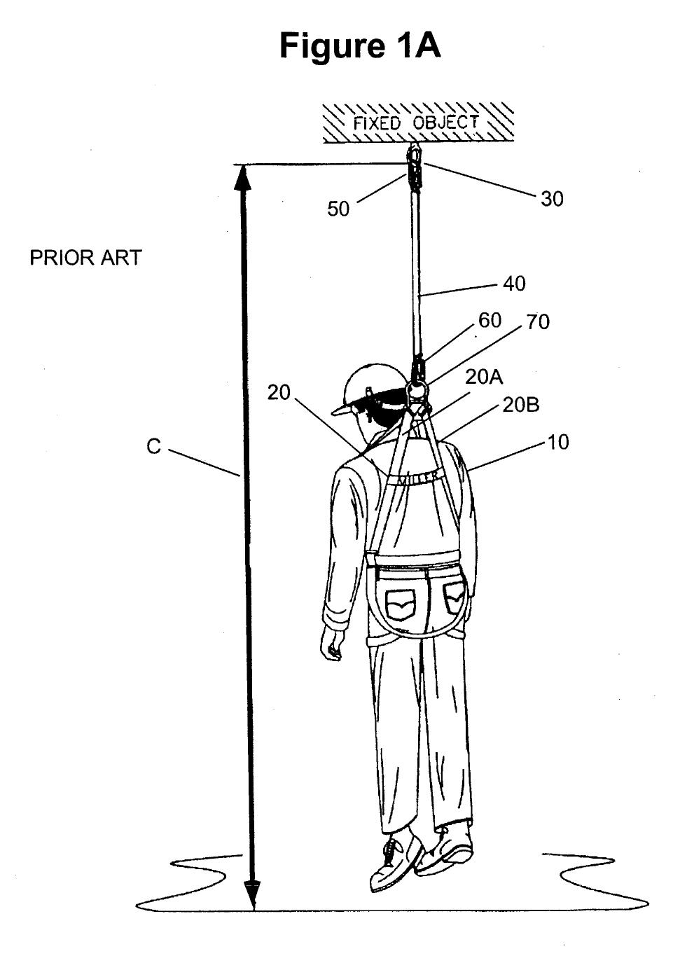

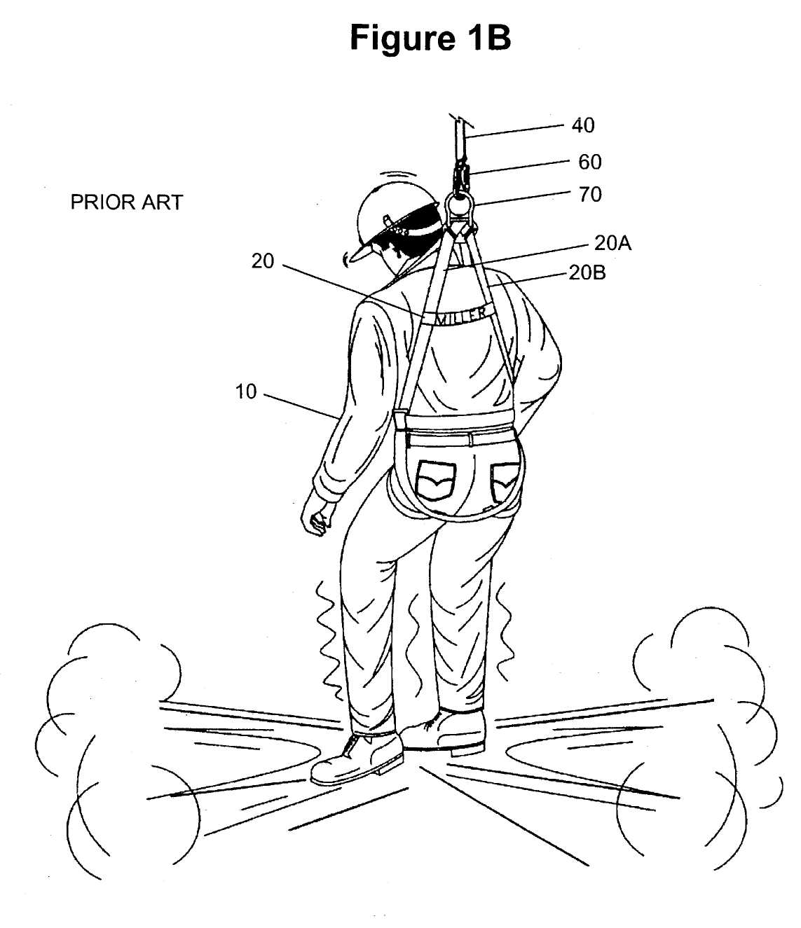

FIGS. 1A illustrates a person 10 in a safety harness 20 suspended from an anchor point 30 via a lanyard 40. In the embodiment of FIG. 1A, lanyard 40 preferably includes a first attachment mechanism 50 (for example, a latch) at a first end thereof to attach lanyard to anchor point 30 (for example, an anchor ring). Lanyard 40 also preferably includes a second attachment mechanism 60 (for example, a latch) at a second end thereof to attach lanyard 40 to an attachment ring 70 on safety harness 20. In the embodiment of FIG. 1, attachment ring 70 is attached to safety harness 20 via shoulder straps 20A and 20B of safety harness 20.

In FIG. 1A, the minimum clearance required to prevent person 10 from striking the ground in the case of a fall is represented by length C that is defined as the distance from anchor point 30 to the ground or any other nearest solid object (for example, flooring in a construction project) below anchor point 30 that would be contacted by person 10 in the case of an unarrested or improperly arrested fall. In FIG. 1A, lanyard 40 has been used properly, stopping the fall of person 10 before any portion of the body has traveled length C from the anchor point 30.

In FIG. 1B, however, an accident is illustrated in the case of a fall wherein the minimum clearance has been miscalculated. In FIG. 1B, not enough clearance was provided and upon extension of lanyard 40, and the lower extremities of person 10 struck the ground.

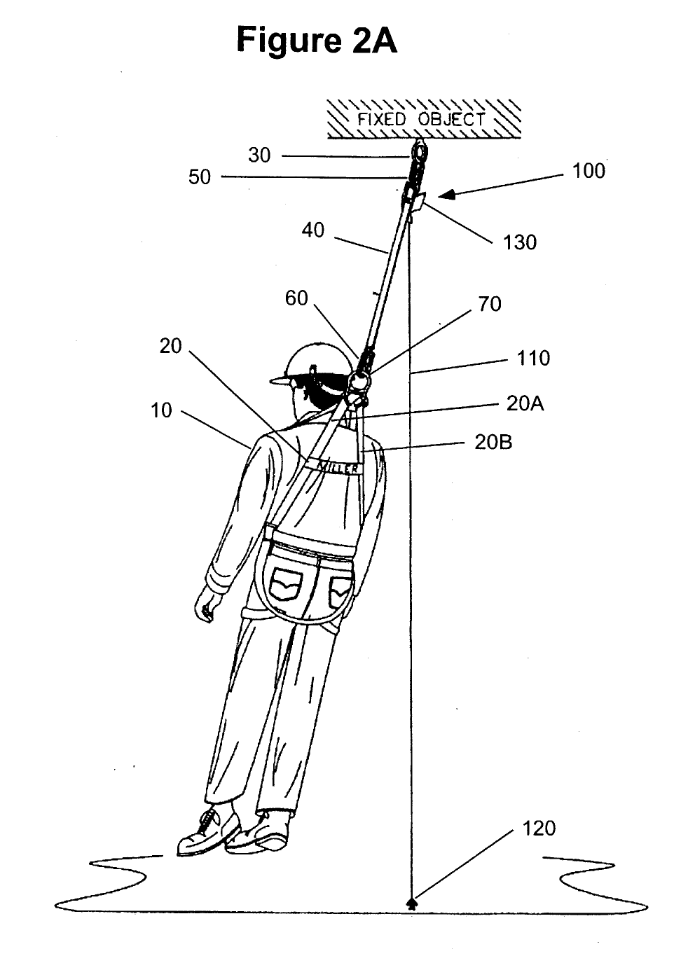

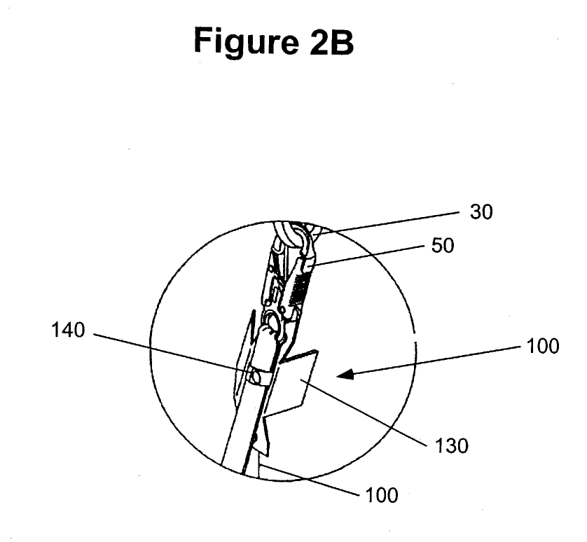

FIGS. 2A illustrates person 10 in safety harness 20 suspended from and anchor point 30 via a lanyard 40. Lanyard 40 once again includes a first attachment mechanism 50 at a first end thereof to attach lanyard to anchor point 30. Lanyard 40 also includes a second attachment mechanism 60 at a second end thereof to attach lanyard to attachment of attachment ring 70 on safety harness 20.

Attached to lanyard 40 in the embodiment of FIG. 2A is a clearance indicator 100. Clearance indicator 100 preferably includes a predetermined length of material such as a string or chord 110 that is attached at one end thereof to lanyard 40. The other end of chord 110 is preferably attached to a weight 120. Upon attachment of lanyard 40 to anchor point 30, weight 120 is preferably dropped to extend chord 110 to its full length and thereby provide person 10 with an indication of the whether the minimum clearance required in the case of a fall is available.

FIG. 2B provides an exploded view of the attachment of clearance indicator 100 to lanyard 40. In the embodiment of FIGS. 2A and 2B, clearance indicator 100 preferably includes a pouch or enclosure 130 (for example, including several folds that can be snapped together) to which chord 110 is attached. Enclosure 130 is preferably attached to lanyard 40 via, for example a snap mechanism 140. Before use thereof, chord 110 is preferably wound (for example, around weight 120 or another, generally flat piece of rigid material) within enclosure 130. Enclosure 130 is then opened and weight 120 is dropped, allowing chord 110 to unwind and extend to its full length. Clearance indicator 100 may also comprises a releasable winding mechanism (for example, a spring loaded drum) to wind cord 110 when clearance indicator 100 is not in use.

As clear to one skilled in the art, the length of chord 110 is preferably calculated based upon addition of the length of lanyard 40, the maximum extension of lanyard 40 under force of a fall, the height of person 10 and any vertical travel of attachment ring 70 of safety harness 60 during a fall. As also clear to one skilled in the art, the length of the fall indicator material or chord 110 is preferably computed based upon the specific characteristics of the fall protection equipment being used and will vary depending upon the characteristics of such equipment. The length of the indicator material can be calculated to indicate the minimum required clearance or additional length can be provided to provide a safety factor.

The clearance indicator of the present invention can take forms other than described in FIGS. 2A and 2B. Indeed, the clearance indicator can comprise any measuring mechanism suitable to measure the distance from the anchor point to which the lanyard is (or is to be) anchored to a point at least the clearance distance from the anchor point. The clearance indicator should also preferably provide feedback to the user thereof to indicate whether minimum clearance (or minimum clearance multiplied by a safety factor) is satisfied. In the case of the embodiment of FIGS. 2A and 2B, for example, the user of will hear or see weight 120 strike an obstruction to the path of fall. The user may also see slack in cord 110 if weight 120 comes to rest on an obstruction. Moreover, the user can examine the area surrounding extended chord 110 to ensure that any obstacles in that area are far enough away from chord 100 to not come into contact with person 10 during a fall.

The clearance indicator can, for example, comprise a laser measuring device as known in the laser arts. The laser measuring device can be calibrated to provide an indication to the user (for example, an audible or visible indication) of whether suitable clearance is available.

Although the present invention has been described in detail in connection with the above examples, it is to be understood that such detail is solely for that purpose and that variations can be made by those skilled in the art without departing from the spirit of the invention except as it may be limited by the following claims.

What is claimed is:

1. A fall protection system for use in protecting a person working at a height from a fall, the fall protection system comprising:
a lanyard, the lanyard including an attachment mechanism for attachment of a first end of the lanyard to an anchor point;
a clearance indicator, the clearance indicator includes a measuring mechanism to measure the distance from the anchor point to a point at least a clearance distance from the anchor point, thereby providing an indication of whether the clearance required in the case of a fall is satisfied.

2. The fall protection system of claim 1 wherein the clearance indicator is attached to the first end of the lanyard.

3. The fall protection system of claim 1 wherein the clearance indicator comprises a length of material that is allowed to drop to extend at least the clearance distance.

4. The fall protection system of claim 3 wherein the length of material has a weight attached to the end thereof to facilitate extension of the length of material when dropped.

5. The fall protection system of claim 4 further comprising a safety harness, the safety harness including an attachment mechanism to attach the second end of the lanyard to the safety harness.

6. The fall protection system of claim 5 wherein the length of the length of material is calculated based upon addition of the length of the lanyard, the maximum extension of the lanyard under force of the fall, and the height of the person.

7. The fall protection system of claim 5 wherein the length of the length of material is calculated based upon addition of the length of the lanyard, the maximum extension of the lanyard under force of the fall, the height of the person and any travel of the attachment mechanism of the safety harness during a fall.

8. A method of protecting a person using a lanyard, the method comprising the step of measuring the distance from an anchor point to a point at least a clearance distance from the anchor point to ensure than no obstacles will interrupt the person's fall, the clearance distance being a function of the length of the lanyard.

9. The method of claim 8 wherein the step of measuring the distance from the anchor point to at least the clearance distance from the anchor point comprises the step of extending a length of material from a known position relative to the anchor point.

10. The method of claim 9, further comprising the step of attaching the lanyard to the anchor point.

11. The method of claim 10 wherein the length of material is attached to the lanyard.

12. The method of claim 8 wherein the length of the length of material is calculated based upon addition of the length of the lanyard, the maximum extension of the lanyard under force of the fall, and the height of the person.

13. The method of claim 8 wherein the length of the length of material is calculated based upon addition of the length of the lanyard, the maximum extension of the lanyard under force of the fall, the height of the person and any travel of the attachment mechanism of the safety harness during a fall.

14. A clearance indicator to protect a person using a lanyard, the clearance indicator comprising a measuring mechanism to measure the distance from an anchor point to a point at least a clearance distance from the anchor point, thereby providing an indication of whether the clearance required in the case of a fall is satisfied.

15. The clearance indicator of claim 14 wherein the clearance indicator comprises a length of material that is allowed to drop to extend at least the clearance distance.

16. The clearance indicator of claim 15 wherein the length of material has a weight attached to the end thereof to facilitate extension of the length of material when dropped.

17. The clearance indicator of claim 15 wherein the length of the length of material is calculated based upon addition of the length of the lanyard, the maximum extension of the lanyard under force of the fall, and the height of the person.

18. The clearance indicator of claim 5 wherein the length of the length of material is calculated based upon addition of the length of the lanyard, the maximum extension of the lanyard under force of the fall, the height of the person and any travel of an attachment mechanism of a safety harness worn by the person during a fall.
